(19) United States
(12) Patent Application Publication
(10) Pub. No.: US 2017/0013831 A1
(43) Pub. Date: Jan. 19, 2017

(54) Antimicrobial Glove

(71) Applicant: Tasha Jewell Christo, Plymouth, MA (US)

(72) Inventor: Tasha Jewell Christo, Plymouth, MA (US)

(21) Appl. No.: 14/800,721

(22) Filed: Jul. 16, 2015

(51) Int. Cl. A01N 25/34; A01N 59/16

(52) U.S. Cl. CPC A01N 25/34; A01N 59/16

(57) ABSTRACT

The present invention provides a multiple, long-term use, antimicrobial glove. The glove is formed from one or more layers of textile material with an antimicrobial silver agent incorporated therein. Optionally, the glove may also have additional antimicrobial agents incorporated therein. The glove of the present invention is capable of inhibiting microbes from proliferating on any surface of the glove, during both storage and use, which results in the prevention of malodor, discoloration, and degradation of the glove. The antimicrobial activity of the glove is sustained throughout time and throughout laundering. Additionally, the glove of the present invention is believed to be capable of imparting an antimicrobial effect to surfaces in contact with the antimicrobial glove.

### CROSS-REFERENCES TO RELATE APPLICATIONS

Not Applicable.

### STATEMENT REGARDING FEDERALLY SPONSORED RESEARCH OR DEVELOPMENT

Not Applicable.

### MICROFICHE APPENDIX

Not Applicable.

### BACKGROUND OF THE INVENTION

1. Field of the Invention

The present invention relates to gloves. More specifically, the present invention relates to a multiple, long-term use textile glove having an antimicrobial silver agent incorporated therein. The present invention also relates to a method for manufacturing such a glove.

There are many known designs and widely varying materials used in the construction and manufacturing of gloves which are intended to be worn on the hands for various purposes including, but not limited to, providing warmth and protection of the hands and fingers from environmental elements, infectious diseases and traumatic injuries.

Gloves typically worn for seasonal and general daily use in the civilian population are commonly manufactured from pliable, sometimes elastic, textiles, such as cotton, polyester, spandex, nylon and vinyl, or combinations thereof. Inherent with gloves, and particularly long-term use gloves, is the problem of moisture from the user's hands and other sources becoming trapped in the fabric of the glove and additionally, microbes can be deposited on the glove when coming into contact with contaminated surfaces in the environment. When the gloves are removed following wear, they are often stored in a warm, dark place such as the pocket of a coat or jacket, a drawer or a closet. Such storage conditions are ideal for the proliferation of microbes such as bacteria and fungus. Typically laundering or dry cleaning is necessary to reduce and/or eliminate the microbes on the glove.

2. Description of the Prior Art

There exist prior art patents that pertain to antimicrobial gloves for use in the medical and food preparation fields. Representative examples of these patents, as noted below, disclose a number of different techniques for incorporating antimicrobial activity into gloves used for medical and food preparation applications. The typical usage pattern of gloves in the medical and/or food preparation fields dictates the form of protection required and the general single-use characteristic. These factors influence the design and production of antimicrobial medical and food preparation gloves.

Gloves worn in the medical field by physicians, surgeons, nurses and additional other medical professionals are typically manufactured from thin elastomeric materials such as rubber and worn for the protection of the wearer and the patient against hazardous and potentially infectious matter. Medical gloves are most often single-use and disposable to prevent disease transmission. Generally long term storage is not a necessary consideration.

There are a variety of methods for manufacturing antimicrobial gloves. U.S. Pat. No. 6,913,758 provides for a multiple, long-term use antimicrobial glove formed by one or more layers with an antimicrobial agent such as diiodomethyl-p-tolysulfone, homogenously incorporated into the latex-based matrix.

U.S. Pat. No. 5,089,205 describes an antimicrobial glove manufactured by partial formation of a glove, which is then dipped into a solution containing an antimicrobial agent, followed by curing of the completed glove.

Another antimicrobial glove, U.S. Pat. No. 5,338,565 is made by forming a first latex layer, then forming a second layer by dipping the first layer into antimicrobial material, then forming yet a third layer of latex over the first two layers, followed by subsequent curing to produce a final multi-layer glove.

In another medical glove, the glove itself is directly coated with antimicrobial agents on one or more if its surfaces. The antimicrobial agent is utilized either alone, or in a carrier. U.S. Pat. No. 5,089,205 provides for the coating of either a cured or non-cured glove with an anionic surfactant-neutralized, cationic antimicrobial agent prior to stripping of the final glove.

U.S. Pat. No. 5,031,245 describes incorporation of a non-ionic antimicrobial agent (triclosan) in a glove material prior to forming the glove and additionally it provides for dusting an antimicrobial powder agent on the inner surface of the glove.

Another manner of incorporating antimicrobial agents into a single-use medical gloves is to form the gloves from a material containing an antimicrobial agent wherein the agent migrates from within the structure of the glove to the glove's outer surface as in U.S. Pat. No. 5,725,867, whereas a cationic antimicrobial agent is incorporated homogenously within the synthetic polymer of the formed glove. The plastisol composition polymer allows the outward migration of the antimicrobial agent onto the outer surface of the glove surface of during use.

Other prior art references the permanent incorporation of an antimicrobial agent in the structure of the medical glove. U.S. Pat. No. 5,180,605 provides a glove with premixed 2,4,4′-trichloro-2′ hydroxydiphenyl ether (triclosan) into a natural rubber latex from which the gloves are formed. Such incorporation of a sparingly water-soluble, non-ionic antimicrobial agent into a single-use medical glove provides 6 to 8 hours of antimicrobial protection to the wearer.

Therefore, what is not obvious,distinct, and not contemplated by the prior art, is a multiple, long-term use, textile glove having antimicrobial silver agent incorporated into the material of the glove.

The antimicrobial silver is present in the glove in an effective amount as to significantly, or completely, inhibit the growth of microbial organisms on all surfaces of the glove and additionally may have an antimicrobial effect on the surfaces in contact with the glove. The antimicrobial activity of the glove is sustained throughout time and throughout laundering.

### SUMMARY OF THE INVENTION

It is an object of the present invention to provide a multiple, long-term use glove having an antimicrobial agent.

It is another object of the present invention to provide such a multiple, long-term use glove in which the antimicrobial agent is incorporated into the glove material.

It is still another object of the present invention to provide such a multiple, long-term use glove in which the glove is formed from textile-based material.

It is a further object of the present invention to provide a multiple, log-term use glove in which the glove is formed with one or more layers of glove material.

Still another object of the present invention is to provide such a multiple, long-term use glove with sustained antimicrobial activity throughout time and throughout laundering.

It is yet a further object of the present invention to provide a method for easily and economically manufacturing such a multiple, long-term use glove.

These and other objects of the present invention are achieved by a multiple, long-term use, antimicrobial glove. The glove is preferably formed from one or more layers with each layer comprised of an antimicrobial textile with silver as the antimicrobial agent incorporated therein. Optionally, the glove material may also have additional antimicrobial agents incorporated therein. The glove of the present invention is capable of inhibiting microbes including bacteria and fungi from proliferating on any surface of the glove, during both storage and use, which results in the prevention of malodor, discoloration, and degradation of the glove. The antimicrobial activity of the glove is sustained throughout time and throughout laundering. Additionally, the glove of the present invention may be capable of imparting an antimicrobial effect to surfaces in contact with the glove.

### DETAILED DESCRIPTION OF THE INVENTION

Inherent with gloves, and particularly long-term use textile gloves, is the problem of moisture from the user's hands and other sources becoming trapped in the fabric of the glove and additionally, microbes can be deposited on the glove when coming into contact with contaminated surfaces in the environment. When the gloves are removed following wear, they are often stored in a warm, dark place such as the pocket of a coat or jacket, a drawer or a closet. Such storage conditions are ideal for the proliferation of microbes such as bacteria and fungi. Typically laundering or dry cleaning is necessary to reduce and/or eliminate the microbes on such a glove.

The present invention mitigates this inherent problem by proposing an improved glove having an effective antimicrobial agent incorporated throughout the material of the glove with antimicrobial activity that is sustained throughout time and throughout laundering. The glove of the present invention is suitable for numerous applications in areas including, but not limited to gloves for seasonal wear, daily wear, household usage, sports, professions and industry.

The multiple, long-term use glove is meant to be durable and appropriate for numerous daily activities, while providing warmth and protection to the hands, and would extend to applications with specialized functionality in areas including, but not limited to household, sports, professions and industry. When not in use, such gloves are often stored in warm and dark locations that are conducive to proliferation of bacteria and fungi.

Whereas traditional gloves are readily contaminated with microorganisms through hand to surface contact they do not provide any antimicrobial activity against these acquired biological contaminants. They generally must be laundered to reduce or eliminate the microbes that accumulate and continue to proliferate on the glove. Additionally, the wearers' hands may not be immediately washed or sanitized prior to wearing the gloves, thus contaminating the interior of the glove as well. Microbial growth on both the surface and interior of the glove can result in odors, degradation and discoloration of the glove. It is plausible that potentially harmful microbes can then be transferred from the contaminated glove and deposited on other surfaces.

The glove of the present invention may be formed with textiles made from materials including but not limited to cotton, polyester, spandex, nylon, vinyl, or any combination thereof. The antimicrobial silver agent is incorporated into the textile at quantities sufficient to effect microbial growth.

Silver is a naturally occurring, non-toxic element and historically has numerous applications within medicine. One of the oldest medical applications of antibacterial silver is in wound care and was approved for this use by the FDA (Food and Drug Administration) in the 1920's with the approval of silver sulfadiazine for topical treatment of burn wound patients. In current practice, silver is incorporated into numerous dressings and topical treatments for wounds. Silver reduces the bacterial load in the wound bed, reducing the risk of infection and supporting wound healing.

Newer applications for silver's well-established antimicrobial capabilities have extended to antimicrobial textiles first conceived of as the answer to soft surface contamination in the medical/clinical setting. Antimicrobial silver textiles are now commonly used to help decrease hospital acquired infections(HAI's) by reducing pathogens on soft surfaces such as hospital gowns, bedsheets, mattresses, towels, upholstery, curtains and doctors coats and scrubs.

Manufacturers of antimicrobial textiles readily found additional uses for antimicrobial fabrics in sportswear apparel and undergarments that promise to reduce odors caused by bacteria and fungi that thrive in warm moist environments.

Silver can be incorporated into textiles in various manners to impart an antimicrobial effect including but not limited to the silver being bonded to the thread fibers which are then woven into a fabric, being imbedded into the core of the thread fibers that are then woven into a fabric, being applied as an infused treatment to a finished fabric or being applied as a coating to a finished textile.

In the initially conceived embodiment of the present invention the glove is a seasonal and/or daily wear glove idealized for the civilian population, and more specifically for the urban commuter.

By daily wear commuter glove, it is meant a durable, long-term use glove that is appropriate for activities commonly engaged in during daily travels typical of an urban worker/commuter. Such activities are believed to include, but not limited to, travels through highly populated public facilities, possibly including travel via public forms of transportation, such as buses, subways, trains and taxis.

Gloves are often worn seasonally for protection and warmth, and can retain moisture from the user's hands and become moist from other sources that then become trapped in the fabric. In addition, in highly populated public environments, the gloves are likely to come into contact with unsanitary surfaces where they may acquire potentially infectious microbes. After use, the gloves are removed and typically stored a coat or jacket pocket, closet or drawer where the warmth and lack of light are conducive to proliferation of microbes such as bacteria and fungi. Commonly, gloves will be worn repeatedly over extended periods of time without being laundered.

Additionally, the user's hands may not be immediately washed or sanitized prior to donning the gloves which can contaminate the interior of the glove as well. Growth of microbes on and in the glove can result in malodor, degradation and discoloration of the glove. Potentially harmful microbes proliferating on the glove may plausibly be transferred to surfaces that come into contact with the glove.

In one embodiment of the present invention the glove may be formed from a textile with woven fibers permanently bonded with a layer of 99.9% pure metallic silver, such as sold by X-STATIC®, Noble Biomaterials. A silver layer creates an ionic shield that permanently inhibits the growth of bacteria and fungi. Fabrics made with X-STATIC® fibers are flexible, with the natural look and feel of traditional textiles. X-STATIC® is a registered antimicrobial agent with the United States Environmental Protection Agency (EPA).

In another embodiment of the present invention, a non-nano antimicrobial silver salt is embedded into the core of the textile fibers which are then woven into fabrics such as sold by PurThread®, PurThread Technologies, Inc.

Kodak® has registered a non-nano antimicrobial silver salt with the EPA and has granted PurThread® license for its use in textiles to keep fabrics fresh and protected against mold, mildew, fungus, and odor-causing bacteria. The embedded protection means the antimicrobial properties won't weaken, wear off, or wash away over time. Studies show 100 industrial washings have no effect on PurThread's antimicrobial effectiveness.

Optionally, the glove materials may contain additional components such as, but not limited to pigments, cross-linkers, extenders, antidegradants, stabilizers and curing components.

Optionally, the glove materials may contain additional antimicrobial agents such as but not limited to, copper ions. Additional antimicrobial agents are believed to work synergistically with silver to increase the overall antimicrobial activity.

The antimicrobial glove of the present invention can be manufactured in a time and cost effective manner, since the antimicrobial silver textiles require no reconfiguring or modification of current manufacturing equipment used to construct traditional textile gloves. The textiles, such as produced by X-STATIC® and PurThread® maintain the same pliability, look and feel of standard textiles, and thus, requires no additional manufacturing steps and no special care, equipment or handling.

The foregoing is illustrative of the present invention and is not intended to limit the invention to the specifically described embodiments. Variations and changes, as would be obvious to one skilled in the art, are intended to be within the scope and nature of the present invention, as defined in the appended claims.

### DRAWINGS

There are no drawings for this application

Wherefore I claim:

1. An antimicrobial glove comprising: a glove having a textile composition and an antimicrobially effective amount of antimicrobial silver incorporated into the textile of said glove.

2. The glove of claim 1, wherein said glove is formed of one or more layers of said glove material.

3. The glove of claim 2, wherein at least one of said one or more layers of said glove material has an antimicrobially effective amount of antimicrobial silver incorporated throughout.

4. The glove of claim 1, further comprising at least one additional antimicrobial agent.

5. The glove of claim 4, wherein said at least one additional agent is selected from the group consisting of: triclosan, silane, fluorescent material, biguanide, chlorohexidene salt, dextran sulfate, quaternary ammonium salt, benzalkonium, acriflavine, acridine dye, gentian violet, mercurochrome, halogen releasing agents, chitosan, photo catalytic reducers, extract of blue green algae, bamboo-derived fibers, antimicrobial polymers, oligodynamic metals, such as copper, zinc, titamium and gold, and any combination thereof.

6. The glove of claim 1, wherein said glove material further comprises a component selected from the group consisting of one or more: surfactants, cross-linkers, antidegradants, cure accelerators, cure activators, stabilizers, pigments, extenders, and any combinations thereof.
